(19) United States
(12) Patent Application Publication
(10) Pub. No.: US 2014/0342440 A1
(43) Pub. Date: Nov. 20, 2014

(54) Coir based bioremediation cleaning products and associated methods

(71) Applicant: Robert Toby Wilson, Riverdale, UT (US)

(72) Inventor: Robert Toby Wilson, Riverdale, UT (US)

(21) Appl. No.: 14/120,276

(22) Filed: May 14, 2014

Related U.S. Application Data
(60) Provisional application No. 61/823,043, filed on May 14, 2013.

(51) Int. Cl. B09C 1/10; B01J 20/22; A62D 3/02

(52) U.S. Cl. CPC B09C 1/10; A62D 3/02; B01J 20/22
USPC 435/262.5; 435/264; 252/184

(57) ABSTRACT

Methods and products for spill response management also providing bioremediation of specific substrates such as protein, starch, carbohydrates, hydrocarbons, fats and greases through superior enzymatic activity in both aerobic and anaerobic environments with one product. In one illustrative embodiment, a product may include coir in a proportion of from about 85% to about 99% and a suitable microbe for initiating bioremediation in an appropriate form in a proportion of from about 20% to about 1%, by weight. Methods of using a product may include absorbing spilled fluid with the product then disposing of the product with the absorbed fluid where the microbe will perform bioremediation. This may allow the absorption (cleanup) of commonly used hazardous and non-hazardous chemicals in residential, commercial and industrial applications and the peace of mind of using a safe, sustainable, environmentally friendly, landfill safe product.

### CROSS REFERENCE TO RELATED APPLICATIONS

This application claims priority to and incorporates by reference all of the subject matter included in Provisional Patent Application Ser. No. 61/823,043, which was filed May 14, 2013.

### TECHNICAL FIELD

The present disclosure relates to products and methods for the cleanup of spills, including petroleum and organics solvent spills, and more specifically to products and methods for collecting spilled fluids and beginning bioremediation of the waste products.

### BACKGROUND

The cleanup of spills usually requires an absorbent to absorb free fluid. The absorbent then is disposed of, or squeezed to remove the fluid and reused. One absorbent that is currently used is coir. One advantage of coir is that once it has absorbed certain fluids, such as petroleum fluids, the fluids are “locked” into the coir and cannot be removed by squeezing, as is done with peat moss and other fibers. While this can be advantageous for cleaning, it can also delay bioremediation efforts. Further, it prevents coir from being used in certain cleanup applications where users attempt to reclaim oil by squeezing it from reusable mats. Clay-based absorbents can similarly allow retained oil to “seep out” or leach therefrom which can interfere with bioremediation as the oil leaches out into the surrounding environment. While in certain situations, this leaching can allow remediation to take place over time as the oil is released, it often complicates cleanup efforts and can even lead to contamination in additional areas, thus requiring additional cleanup.

Methods and products that allowed for the advantageous use of coir absorbents while initiating bioremediation prior to the removal would be an improvement in the art. Such methods or products that allowed for the absorbed fluid to be disposed of in a standard fashion as a non-hazardous waste and resulted in in situ bioremediation of the waste would be a further improvement in the art.

### SUMMARY

The present disclosure is directed to methods and products for spill response management also providing bioremediation of specific substrates such as protein, starch, carbohydrates, hydrocarbons, fats and greases through superior enzymatic activity in both aerobic and anaerobic environments with one product. In one illustrative embodiment, a product may include coir in a proportion of from about 85% to about 99% and a suitable microbe for initiating bioremediation in an appropriate form in a proportion of from about 20% to about 1%, by weight. Methods of using a product may include absorbing spilled fluid with the product then disposing of the product with the absorbed fluid where the microbe will perform bioremediation. This may allow the absorption (cleanup) of commonly used hazardous and non-hazardous chemicals in residential, commercial and industrial applications and the peace of mind of using a safe, sustainable, environmentally friendly, landfill safe product.

### DETAILED DESCRIPTION

The present disclosure relates to apparatus, systems and methods related to absorbent products for bioremediation. It will be appreciated by those skilled in the art that the embodiments herein described, while illustrative, are not intended to so limit the scope of the appended claims. Those skilled in the art will also understand that various combinations or modifications of the embodiments presented herein can be made without departing from the scope of this disclosure. All such alternate embodiments are within the scope of the appended claims.

In this specification and in the claims which follow, reference will be made to a number of terms which shall be defined to have the following meanings.

As used herein and in the appended claims, the singular forms “a”, “an”, and “the” include plural reference unless the context clearly dictates otherwise. For example, reference to “a microbe” includes a plurality of such microbes.

As used herein, “comprising,” “including,” “containing,” “characterized by,” and grammatical equivalents thereof are inclusive or open-ended terms that do not exclude additional, unrecited elements or method steps, but also includes the more restrictive terms “consisting of” and “consisting essentially of.”

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

“Optional” or “optionally” means that the subsequently described event or circumstance may or may not occur, and that the description includes instances where said event or circumstance occurs and instances where it does not.

The term “suitable” as used herein refers to a group that is compatible with the compounds, products, or compositions as provided herein for the stated purpose. Suitability for the stated purpose may be determined by one of ordinary skill in the art using only routine experimentation.

The present disclosure is directed to methods and products for spill response management also providing bioremediation of specific substrates such as protein, starch, carbohydrates, hydrocarbons, fats and greases through superior enzymatic activity in both aerobic and anaerobic environments with one product. In one illustrative embodiment, a product may include coir in a proportion of from about 85% to about 99% and a suitable microbe for initiating bioremediation in an appropriate form in a proportion of from about 15% to about 1%, by weight. Methods of using a product may include absorbing spilled fluid with the product then disposing of the product with the absorbed fluid where the microbe will perform bioremediation. This may allow the absorption (cleanup) of commonly used hazardous and non-hazardous chemicals in residential, commercial and industrial applications and the peace of mind of using a safe, sustainable, environmentally friendly, landfill safe product.

Absorbent products in accordance with the teachings of the present disclosure may be capable of absorbing liquid spills of all fluids in varying viscosities from Fuels, Oils, Transmission Fluid, Antifreeze, Solvents, Water-Based Chemicals, Pesticides & Herbicides, Mild Corrosives (Acids & Caustics) to Bodily Fluids and Organic Wastes. Thus such products may be useful for Spill Response and Spill Management programs and general use in residential, municipal, commercial and industrial applications. By the incorporation of suitable microorganisms, the products may provide organic waste degradation and bioremediation benefits, while also achieving cleaning and odor control performance. Degradation of fats, oils, grease, tissue and detergents retained in the absorbent product may be especially advantageous.

In a first basic form, a bioremediating absorbent material in accordance with the present disclosure may contain coconut coir, such as Coconut Coir Fiber Pith having a moisture content of from about 15% to about 20% H₂O by volume. The coconut coir may be manufactured in a loose granulated grade, a compressed pellet grade, or a suitable mixture thereof which allows a user to choose the correct grades desired for as specific application. As a naturally occurring product, coir is completely biodegradable, but in a landfill setting takes a long period, such as about 20 years to completely degrade. This long time frame provides a suitable encapsulation for the spilled hydrocarbon and allows for its complete bioremediation digestion prior to the complete biodegradation of the coir. Thus eventually, both the spilled hydrocarbon and the absorbent are completely degraded.

The bioremediating absorbent material in accordance with the present disclosure may further contain one or more microbes for breaking down oily waste in a suitable form and amount for beginning bioremediation of waste absorbed into the coir. Suitable microbes include bacteria in a dormant state, or bacterial spores. A blend of one or more microbes may used for additional or increased functionality. One example of a suitable blend that may be used is the commercially available BI-CHEM® SB Concentrate from Novozymes®. This concentrate is sold as a powder intended as a dry septic and waste degrader and is a blend of Bacillus spores characterized with a bacteria count: of about 10.0×10⁹ cfu/gram. The included microbes produce Lipase, Protease, Amylase, and/or Cellulase and are capable of both aerobic and facultative anaerobic digestion. It will be appreciated that other suitable microbes may be used and are within the scope of the present invention.

By using coir in conjunction with the microbes, the absorbed hydrocarbon material is contained in a absorbent material from which it will not leach, while simultaneously is able to be remediated by the microbes though the digestive process. Coir fiber pith contains naturally occurring hollow channels which allow the microbes to access the absorbed hydrocarbon material in the pith, and to receive moisture, air other nutrients from the surrounding environment. Additionally, the moisture content of the coir may be used by the microbes for digestion and survival.

Methods for using the product in accordance with this disclosure may include the absorbing of a spilled liquid hydrocarbon, such as automotive or cooking oil, or other hydrocarbon, with the material. The liquid hydrocarbon is then absorbed therein and due to the non-leaching properties of the coir may be disposed of as non-hazardous waste. The microbes then begin the process of bioremediating the hydrocarbon which is retained in the absorbent material. This may occur under anaerobic conditions, for example, where disposal is made into a landfill, where it is buried or sealed in place. In other embodiments, it may be disposed of under aerobic conditions. Where the waste is transported for disposal on trains or barges, this may allow bioremediation to begin and continue during transport, and in the event of spillage or inadvertently inappropriate disposal may allow remediation to continue or complete reducing potential environmental impacts.

It is estimated that methods in accordance with the present disclosure reduce the time for breaking down liquid hydrocarbons in a landfill from a typical 3 to four years to about a quarter of that time for liquid hydrocarbons absorbed into a bioremediating absorbent material in accordance with this disclosure.

### Example I

A first sample of a product was prepared by mixing about 1.0 pounds of shredded coconut coir with about 0.8 ounces of Novozymes® BI-CHEM® SB Concentrate to achieve about a 5% ratio by weight.

### Example II

A second sample of a product was prepared by mixing about 1.0 pounds of shredded coconut coir with about 1.6 ounces of Novozymes® BI-CHEM® SB Concentrate to achieve about a 10% ratio by weight.

### Example III

A third sample of a product was prepared by mixing about 1.0 pounds of shredded coconut coir with about 2.4 ounces of Novozymes® BI-CHEM® SB Concentrate to achieve about a 15% ratio by weight.

### Example IV

A fourth sample of a product was prepared by mixing about 1.0 pounds of shredded coconut coir with about 3.2 ounces of Novozymes® BI-CHEM® SB Concentrate to achieve about a 20% ratio by weight.

### Example V

A fifth sample of a product was prepared by mixing about 1.0 pounds of shredded coconut coir with about 4.0 ounces of Novozymes® BI-CHEM® SB Concentrate to achieve about a 25% ratio by weight.

### Example VI

Samples of the products from Examples I through V are prepared. A sufficient amount of each product is used to absorb a 100 mL of used oil placed on a flat surface to simulate a spill. The sample is placed in a sealed container to maintain an anaerobic condition. The sample is analyzed at suitable time intervals to determine if bioremediation of the absorbed oil is occurring. Analysis shows that breakdown of the oil occurs as expected.

### Example VII

Samples of the products from Examples I through V are prepared. A sufficient amount of each product is used to absorb a 100 mL of used oil placed on a flat surface to simulate a spill. The sample is placed in an open container to maintain an aerobic condition. The sample is analyzed at suitable time intervals to determine if bioremediation of the absorbed oil is occurring. Analysis shows that breakdown of the oil occurs as expected.

### Example VIII

A first sample (A) was prepared in accordance with Example II above from: 1 lb. coconut absorbent and 1.6 oz Bi-Chem SB concentrate. Similarly, a second sample (B) was prepared in accordance with Example I above from: 1 lb. coconut absorbent and 0.8 oz Bi-Chem SB concentrate.

One gram of each sample was weighed and transferred into an individual sterile buffer bottle. The samples were mixed for one hour to physically separate the spores from the base material. After shaking the base material was allowed to settle, then total and spore counts were performed on the supernatant. Total counts capture the total number of bacteria in a sample, whereas the spore count captures only those that are in spore form. If the two counts are similar it indicates that the majority of the bacteria are spore formers. Count results are shown in Table I, below.

TABLE I
Bacterial Counts

| | | Expected | Actual |
|---|---|---|---|
| Sample A | TC* | 1.00e9 | 1.35e9 |
| | SC** | 1.00e9 | 9.57e8 |
| Sample B | TC | 5.00e8 | 7.17e8 |
| | SC | 5.00e8 | 6.17e8 |

*TC = Total Count
**SC = Spore Count

Based on the actual results, it appears the products are being mixed properly and meeting the expected bacterial counts.

### Example IX

Samples of the products from Examples I through V are prepared with a substitution. The microbe portion used is Young Enterprises Microbial Powder, commercially available from Young Enterprises, LLC of Norwell, Mass.

While this invention has been described in certain embodiments, the present invention can be further modified with the spirit and scope of this disclosure. This application is therefore intended to cover any variations, uses, or adaptations of the invention using its general principles. Further, this application is intended to cover such departures from the present disclosure as come within known or customary practices in the art to which this invention pertains and which fall within the limits of the appended claims.

What is claimed is:

1. A method of remediating a spilled liquid hydrocarbon, the method comprising:
absorbing the spilled liquid hydrocarbon with an bioremediating disposal material comprising an absorbent material from which an absorbed hydrocarbon will not leach in a proportion of from about 85% to about 99% by weight and a suitable microbe for digestion of hydrocarbon waste in an appropriate form for beginning bioremediation of waste absorbed in the absorbent material in a proportion of from about 15% to about 1% by weight, and
disposing of the bioremediating disposal material with absorbed hydrocarbon as a non-hazardous waste under conditions in which bioremediation will occur.

2. The method according to claim 1, wherein absorbing the spilled liquid hydrocarbon with an bioremediating disposal material comprising an absorbent material from which an absorbed hydrocarbon will not leach comprises absorbing the spilled liquid hydrocarbon with a bioremediating disposal material comprising coconut coir in a proportion of from about 85% to about 99% by weight.

3. The method according to claim 2, wherein absorbing the spilled liquid hydrocarbon with a bioremediating disposal material comprising coconut coir in a proportion of from about 85% to about 99% by weight comprises absorbing the spilled liquid hydrocarbon with a bioremediating disposal material comprising coconut coir in a proportion of about 90% and a suitable microbe for digestion of hydrocarbon waste in an appropriate form for beginning bioremediation of waste absorbed in the absorbent material in a proportion of about 10% by weight.

4. The method according to claim 2, wherein absorbing the spilled liquid hydrocarbon with a bioremediating disposal material comprising coconut coir comprises absorbing the spilled liquid hydrocarbon with an absorbent material comprising coconut coir fiber pith having a moisture content of from about 15% to about 20% H₂O.

5. The method according to claim 2, wherein absorbing the spilled liquid hydrocarbon with an absorbent material comprising coconut coir comprises absorbing the spilled liquid hydrocarbon with an absorbent material comprising coconut coir fiber pith in a loose granulated grade, a compressed pellet grade, or a mixture thereof.

6. The method according to claim 1, wherein absorbing the spilled liquid hydrocarbon with an bioremediating disposal material comprising an absorbent material from which an absorbed hydrocarbon will not leach in a proportion of from about 85% to about 99% by weight and a suitable microbe for digestion of hydrocarbon waste in an appropriate form for beginning bioremediation of waste absorbed in the absorbent material in a proportion of from about 15% to about 1% by weight comprises absorbing the spilled liquid hydrocarbon with an absorbent material comprising bacteria in a dormant state or bacterial spores.

7. The method according to claim 6, wherein absorbing the spilled liquid hydrocarbon with an absorbent material comprising bacteria in a dormant state or bacterial spores comprises absorbing the spilled liquid hydrocarbon with an absorbent material comprising a blend of different microbes.

8. The method according to claim 6, wherein absorbing the spilled liquid hydrocarbon with an absorbent material comprising bacteria in a dormant state or bacterial spores comprises absorbing the spilled liquid hydrocarbon with an absorbent material comprising bacteria or bacterial spores in a powdered concentrate form.

9. The method according to claim 8, wherein absorbing the spilled liquid hydrocarbon with an absorbent material comprising bacteria or bacterial spores in a powdered concentrate form comprises absorbing the spilled liquid hydrocarbon with an absorbent material comprising a powder comprising a blend of Bacillus spores having a bacteria count of about 10.0×10⁹ cfu/gram.

10. The method according to claim 1, wherein disposing of the bioremediating disposal material with absorbed hydrocarbon as a non-hazardous waste under conditions in which bioremediation will occur comprises disposing of the bioremediating disposal material with absorbed hydrocarbon so that it is retained in anaerobic conditions.

11. The method according to claim 10, wherein disposing of the bioremediating disposal material with absorbed hydrocarbon so that it is retained in anaerobic conditions comprises disposing of the bioremediating disposal material into a waste disposal landfill.

12. The method according to claim 1, wherein disposing of the bioremediating disposal material with absorbed hydrocarbon as a non-hazardous waste under conditions in which bioremediation will occur comprises disposing of the bioremediating disposal material with absorbed hydrocarbon so that it is retained in aerobic conditions.

13. A bioremediating disposal material for absorbing spilled liquid hydrocarbons, comprising:
an absorbent material comprising coconut coir fiber pith in a proportion of from about 85% to about 99% by weight; and
a suitable microbe for digestion of hydrocarbon waste in an appropriate form for beginning bioremediation of waste absorbed in the absorbent material in a proportion of from about 15% to about 1% by weight.

14. The bioremediating disposal material of claim 13, wherein the coconut coir fiber pith is a loose granulated grade, a compressed pellet grade, or a mixture thereof.

15. The bioremediating disposal material of claim 13, wherein the coconut coir fiber pith is present in a proportion of about 90% and a suitable microbe for digestion of hydrocarbon waste in an appropriate form for beginning bioremediation of waste absorbed in the absorbent material is present in a proportion of about 10% by weight.

16. The bioremediating disposal material of claim 13, wherein the coconut coir comprises coconut coir fiber pith having a moisture content of from about 15% to about 20% H₂O.

17. The bioremediating disposal material of claim 13, wherein the suitable microbe for digestion of hydrocarbon waste in an appropriate form for beginning bioremediation of waste absorbed in the absorbent material in a proportion of from about 15% to about 1% by weight comprises bacteria in a dormant state or bacterial spores.

18. The bioremediating disposal material of claim 17, wherein the bacteria in a dormant state or bacterial spores comprises a blend of different microbes.

19. The bioremediating disposal material of claim 17, wherein the bacteria in a dormant state or bacterial spores comprises bacteria or bacterial spores in a powdered concentrate form.

20. The bioremediating disposal material of claim 19, wherein the bacteria or bacterial spores in a powdered concentrate form comprises a powder comprising a blend of Bacillus spores having a bacteria count of about 10.0×10⁹ cfu/gram.
